(19) United States
(12) Patent Application Publication
(10) Pub. No.: US 2002/0113399 A1
(43) Pub. Date: Aug. 22, 2002

(54) S. S. suspension

(76) Inventors: Marcus Shawn Fehler, Independence, KY (US); Gregory Scott Bush, Walton, KY (US)

Correspondence Address: Gregory Scott Bush, 12595 Percival Road, Walton, KY, 41094, US

(21) Appl. No.: 09/784,111

(22) Filed: Feb. 16, 2001

(51) Int. Cl. B62D 1/00

(52) U.S. Cl. 280/124.165; 280/124.164

(57) ABSTRACT

The S.S. Suspension is a pro-active progressive shocking system. The system consists of a front and rear mounted shocking system. The shock mounts adjust to compensate for the external forces on the vehicle. The shock absorbers are mounted to this mounting system in coil over fashion. The S.S. Suspension allows the tires on a vehicle to keep a more consistent and aggressive grip on the contact surface. The suspension allows the chassis to float between the front and rear shocking systems which creates nearly zero chassis roll and an extremely low center of gravity. The suspension system also allows for more controllable vehicle handling over unlevel terrain. This innovative design allows the vehicle to react separately from the suspension system.

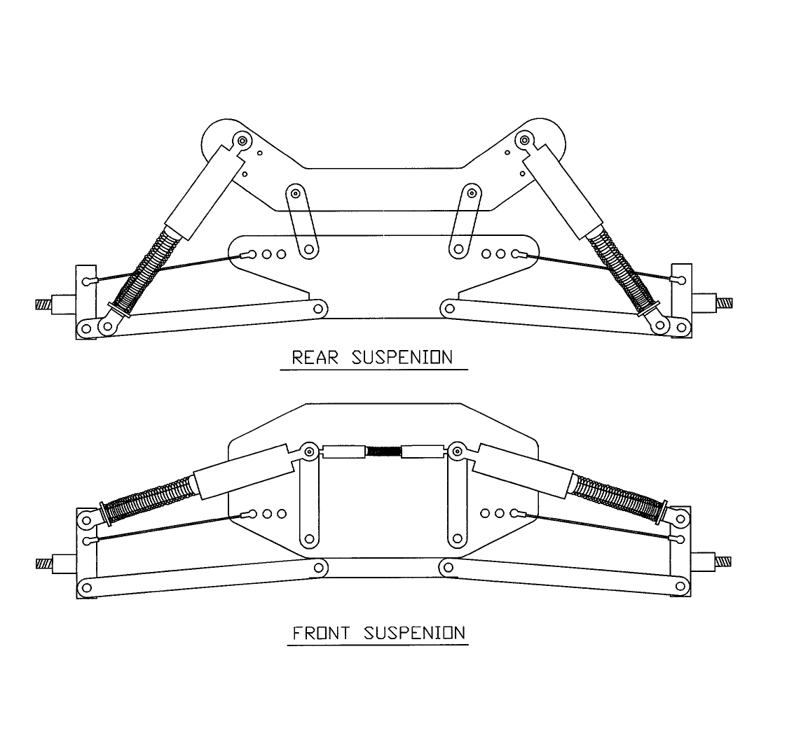

### CROSS-REFERENCE TO RELATED APPLICATIONS

Not Applicable

### STATEMENT REGARDING FEDERALLY SPONSORED RESEARCH OF DEVELOPMENT

Not Applicable

### REFERENCE TO A MICROFICHE APPENDIX

Not Applicable

### BACKGROUND OF THE INVENTION

The S.S. Suspension was created to develop a more aggressive, and stable suspension system through rough terrain and racing conditions. With the current vehicles tire roll and camber change there is an issue during cornering. Along with this there was also the problem of chassis roll and the leaning that was created by cornering. The problem of the chassis leaning on terrain of different elevations was also addressed. The suspension was developed to eliminate the chassis roll and cornering issues along with the chassis lean involved in unlevel terrain. This was done by allowing the chassis and the shocking system to act independently from each other.

### BREIF SUMMARY OF THE INVENTION

The S.S. Suspension creates a vehicle which can handle the terrain in a faster more aggressive driving style than that of previous suspensions. The suspension system consists of two members both of which allow the chassis to act independently from the shocking system. The front and rear shocking system is mounted with swing arms that connect to the shock tower. This allows the suspension to level the chassis and adjust to either the gravitational pull or unlevel ground. With this adjustment there is always full shock absorbing capability. This allows for more stability and a firmer ground contact patch with the vehicles tires. This also aids in eliminating chassis roll and the inside tire from lifting during cornering.

### BRIEF DESCRIPTION OF THE SEVERAL VIEWS OF THE DRAWINGS

1. Front View

This figure shows the elevated view of the S.S. Suspension's front shocking system. The figure shows that the system has a shock tower which mounts to the chassis. The A arms are mounted to the chassis. The spindle carrier is mounted at the end of the A arm and the tie-rod is then mounted to the spindle carrier and the shock tower. There are two swing arms connected to the bottom of the shock tower. They are then connected to a center shock which is adjustable to control the stiffness. There are two independent shocks mounted to either side of the shock tower formed by the swing arms and the center shock. These independent shocks are then mounted to the spindle carrier.

2. Rear View

This figure shows the elevated view of the S.S. Suspension's rear shocking system. The figure shows that the shock tower is mounted to the chassis. The A arms are mounted to the chassis. The spindle carrier is mounted at the end of the A arm and the tie-rod is then mounted to the spindle carrier and the shock tower. There are two swing arms mounted on the top of the shock tower. A shock mounting adjustment plate is then mounted to the top of the swing arms. The shocks are then mounted to the plate in one of the locations. The bottom of the shocks are mounted to the A arms.

### DETAILED DESCRIPTION OF THE INVENTION

The S.S. Suspension project was developed in an effort to create a suspension which would allow for more aggressive driving into and out of turns on a vehicle. The suspension was first applied to a radio controlled vehicle. The idea was to create a suspension which would allow the camber of the tires to stay at the angle set on the tire for a longer period of time creating a better tire grip. The suspension uses a pro-active shock geometry which allows the chassis to stay level and the shock to adjust for the adjustment in the arms without engaging the shock.

The progressive shock mounting allows for two different elements to occur which allows the tires to keep more tire traction in contact with the ground. The shocking system eliminates chassis roll by adjusting to the gravitational pull and the kinetic energy involved in the cornering of the car. Normal suspensions allow the car to lean and roll. This causes the tires to lift off of the ground and the camber of the tire to change. The camber change and lifting of the tires causes the tires to loose their contact patch. The S.S. Suspension adjusts and eliminates virtually all of the chassis roll and lean. The second element is advantageous when the vehicle is run over uneven surfaces. This is due to excessive suspension and chassis leveling capabilities of the S.S. Suspension system. Normally when a vehicle is on unlevel terrain the entire car is leaning. This is not the case with a vehicle using the S.S. Suspension. If the left side of the tires are on ground at one level and the right side tires are on a higher plane the chassis stays level. The shocking system adjust to the new geometry necessary to allow full shocking capabilities without changing the shock compression. The chassis is still level and retains a high ride height.

The S.S. Suspension also creates a faster vehicle. This is due to a near zero center of gravity. The chassis floats and pivots around the entire suspension system. When cornering, the chassis does not roll and push the vehicle through a turn. With the suspension the car chassis remains level and allows for greater speed and tire contact through the cornering.

To prove this several tests were performed. First the suspension was tested running the vehicle through terrain which was unlevel and demanded a large amount of shock absorption. The second test was using the vehicle in both low and high speed cornering situations, such as pavement, dirt, mud, wet road conditions, loose road conditions, sand covered terrain, and race conditions.

We claim:

1. A suspension system comprising of: the chassis of the vehicle is connected to two swinging points comprising; a bulkhead mount which supports, a lower shock tower in both the front and rear of the vehicle, also the A arms for both the right and left side are connected to the bulkhead; there are two swing arms which are then mounted to the lower shock tower; there is a spindle carrier which is mounted at the end of the A arm, which is then connected to the lower shock tower using adjustable tie-rods

2. The front shock tower consists of the suspension according to claim 1, where an adjustable shock is then connected to the two swing arms; the complete shock tower is mounted to the shocks at the connecting points of the swing arms and the connecting shock; the lower end of each shock is mounted to the top of the spindle carrier.

3. The rear shock tower consists of the suspension according to claim 1, where a shock mounting plate with adjustable shock mounting location holes is connected to the two swing arms; the tops of the shocks are then mounted into the desired location hole, the lower end of the shock is then mounted into the shock mounting location hole in the rear A arm.

4. The completed front shocking system according to claims 1,2, allow for a greater degree of shock adjustments; the stiffness of the center shock can be adjusted to allow for; no movement of the center shock, or to allow the center shock to absorb bumps before the two independent shocks are engaged.

5. The completed suspension system according to claims 1,2,3, creates a shocking system which allows the shock position to adjust to the terrain conditions; without affecting chassis lean, tire camber, or compressing each independent shock.

6. The completed suspension system according to claims 1,2,3, allows for greater A arm travel through ruff or unlevel terrain at greater degrees without causing chassis lean.

7. The complete suspension system according to claims 1,2,3, allows for both of the vehicle's tires to divide the impact off of a jump at the landing point more consistently.

8. The complete suspension system according to claims 1,2,3, allows for all four tires on the vehicle to have a more consistent and equal contact patch through cornering by reducing the gravitational pull on the inside tires of the vehicle and the chassis of the vehicle.
